(19) United States
(12) Patent Application Publication
(10) Pub. No.: US 2018/0268049 A1
(43) Pub. Date: Sep. 20, 2018

(54) PROVIDING A HEAT MAP OVERLAY REPRESENTATIVE OF USER PREFERENCES RELATING TO RENDERED CONTENT

(71) Applicant: Justhive, LLC, Glendale, CA (US)

(72) Inventor: Armen Youssefian, Glendale, CA (US)

(21) Appl. No.: 15/917,056

(22) Filed: Mar. 9, 2018

Related U.S. Application Data
(60) Provisional application No. 62/473,992, filed on Mar. 20, 2017.
(60) Provisional application No. 62/638,875, filed on Mar. 5, 2018.

(51) Int. Cl. G06F 17/30; G06K 9/62; H04L 29/08; G06K 9/00; G06F 9/451

(52) U.S. Cl. CPC G06F 17/30601; G06K 9/6218; H04L 67/36; H04L 67/42; H04L 67/18; G06K 9/00671; G06F 9/451; H04L 67/22

(57) ABSTRACT

A system and method for generating a heat map overlay for superposition over image content rendered by a plurality of user devices. User input data corresponding to user inputs received by the plurality of user devices with respect to the image content is provided to a processor. The user input data identifies points in the image content at which the user inputs were respectively received by the devices. The user inputs are clustered so as to provide a density of user input relative to the image content. A heat map overlay representative of the density of the user inputs relative to the image content is generated for display by the plurality of user devices.

### CROSS-REFERENCE TO RELATED APPLICATIONS

The present application claims the benefit of priority under 35 U.S.C. § 119(e) of U.S. Provisional Application Ser. No. 62/473,992, entitled PROVIDING A HEAT MAP OVERLAY REPRESENTATIVE OF USER PREFERENCES RELATING TO RENDERED CONTENT, filed Mar. 20, 2017 and of U.S. Provisional Application Ser. No. 62/638,875, entitled PROVIDING A HEAT MAP OVERLAY REPRESENTATIVE OF USER INTEREST IN TEXTUAL CONTENT, filed Mar. 5, 2018, the content of each of which are incorporated by reference herein in their entireties.

### FIELD

This disclosure relates generally to facilitating user interaction with content rendered by devices in communication with computer networks. More particularly, this invention relates to techniques for representing such user interaction.

### BACKGROUND

Various techniques exist for monitoring user engagement with content such as photos, videos or other multimedia content. For example, “likes” of content supplied by users of a social network may be recorded and displayed in association with the content. Commercial providers of content are also interested in understanding whether a content item has engaged viewers.

However, in the case of complex images containing numerous items of potential interest, it may be difficult to subsequently discern which aspect of an image prompted a user to engage with the image or otherwise “like” it. The same holds true in the case of video content, for which it is generally not possible to discern if a particular frame or sequence of frames within a video were responsible for prompting the user to rate the video content favorably. Similarly, the generalized “liking” of content containing text does not provide information as to which portions, if any, of the textual content is engaging to viewers.

### SUMMARY

Disclosed are systems and methods for generating a heat map overlay designed to be superimposed over digital media content with respect to which users have expressed preferences. The heat map overlay may provide an indication of those portions of the underlying content for which users have expressed preferences such as by, for example, tapping or double tapping on such portions. In one aspect the disclosed system may be characterized as providing a crowdsourced heat map overlay for digital media (e.g., photos or videos) that is generated in response to user input (e.g., via touch or click) made with respect to the digital media.

In the context of a social network, such a heat map overlay can indicate to users of the social network which aspects of an item of digital media, such as a photo or video, were of interest to other users. For example, a user viewing an image may double-tap a specific area of an image that they like.

In the case of a video content, the heat map may indicate which frames of a video and/or which portions of particular frames were of interest to users of a social network. While a video is playing, a user can double-tap at any point of the video in order to like that specific frame of the video and, optionally, a specific area of that particular frame. After input from multiple users has been aggregated, the resulting heat map overlay can be superimposed over a particular video or video frame being rendered.

In one implementation the heat map is generated using clustering algorithms to combine and weight user touches so that user interfaces can efficiently show points of interest in an image as an aggregation of user touches or clicks.

The disclosed heat map overlay also can represent metadata related to user input by treating inputs differently when computing heat map cluster weight. The input treatment can be any form of metadata including, but not limited to: relative time of input, geographical distance from the photo, and number of friends in common with the original creator of the photo. The overlay may be computed dynamically at, for example, a server and served to a user over a network. Alternatively, the overlay may be created on a user's device.

In another aspect the disclosure relates to systems and methods for generating a heat map overlay designed to be superimposed over textual content of, for example, a social media post. The heat map overlay may provide an indication of those portions of the textual content of the post for which users have expressed interest such as by, for example, highlighting such portions via a user interface of a social media application. In this aspect the disclosed system may be characterized as a providing a crowdsourced heat map overlay for textual content that is generated in response to user selection (e.g., highlighting) of portions of such textual content.

An implementation of the disclosed method for generating a heat map overlay may include receiving, by a processor, user input data corresponding to user inputs received by a plurality of user devices with respect to image content rendered by the plurality of user devices. The user input data identifies points in the image content at which the user inputs were respectively received. The method may include clustering, by the processor, the user inputs so as to provide a density of user input relative to the image content. A heat map overlay is generated by the processor for display by the plurality of user devices. In one implementation the heat map overlay is representative of the density of the user inputs relative to the image content.

The clustering may be performed in accordance with a density algorithm configured to cluster the points in the image content, thereby generating a plurality of clusters. Ones of the clusters corresponding to a relatively higher density of user input may be represented as larger regions within the heat map overlay and other of the clusters corresponding to a relatively lower density of user input may be represented as smaller regions within the heat map overlay. In addition, relatively warmer colors may be used within the larger regions when generating the heat map overlay.

In addition to clustering, generating the heat map overlay may involve weighting the points in at least one of the plurality of clusters. The weighting may be based upon, for example, times at which the user inputs corresponding to points in one of the clusters were received. Alternatively or in addition, the weighting may be based upon distances between geographical locations at which the user inputs corresponding to the points in one of the clusters were received and a geographical location associated with the image content.

An implementation of the disclosed system for generating a heat map overlay may include a processor and a memory containing instructions. When executed by the processor, the instructions cause the processor to receive user input data corresponding to user inputs received by a plurality of user devices with respect to image content rendered by the plurality of user devices. The user input data identifies points in the image content at which the user inputs were respectively received. The instructions further cause the processor to cluster the user inputs so as to provide a density of user input relative to the image content. The processor is also caused by the instructions to generate a heat map overlay for display by one or more of the plurality of user devices. In one implementation the heat map overlay is representative of the density of the user inputs relative to the image content.

In another aspect the disclosure relates to a method which involves receiving, through a user interface of a user device, user input with respect to image content rendered by the user interface. The method further includes generating, by a processor, user input data identifying at least one point in the image content at which the user input was received. The user input data may then be sent to a server configured to generate a heat map overlay. The method further includes receiving, at the user device, the heat map overlay. In one implementation the heat map overlay is representative of a density of user inputs applied to a plurality of user devices relative to the image content. Once received by the user device, the heat map overlay may be superimposed over the image content and displayed.

### BRIEF DESCRIPTION OF THE DRAWINGS

FIG. 1 illustrates an exemplary system configured to generate heat map overlays representative of user preferences relating to rendered multimedia and textual content.

FIG. 2 illustrates a social network post of an image designated as a heat map image that is utilized in accordance with an embodiment.

FIG. 3 illustrates a heat map overlay superimposed over an image.

FIG. 4 is an exemplary simplified flow diagram representative of a process for providing heat map overlays, in accordance with some embodiments

FIG. 5 illustrates a heat map overlay generated in response to multiple users providing user input to portions of the same image presented by the user interfaces of their respective client devices.

FIGS. 6-11 illustrate an exemplary series of user interfaces utilized in creating a heat map post.

FIGS. 12-14 illustrate an exemplary series of user interfaces utilized in voting on a heat map post.

FIGS. 15-21 illustrate an exemplary series of user interactions with textual content presented by a user interface as well as heat map feedback reflecting an aggregate user interest in corresponding portions of the textual content.

### DETAILED DESCRIPTION

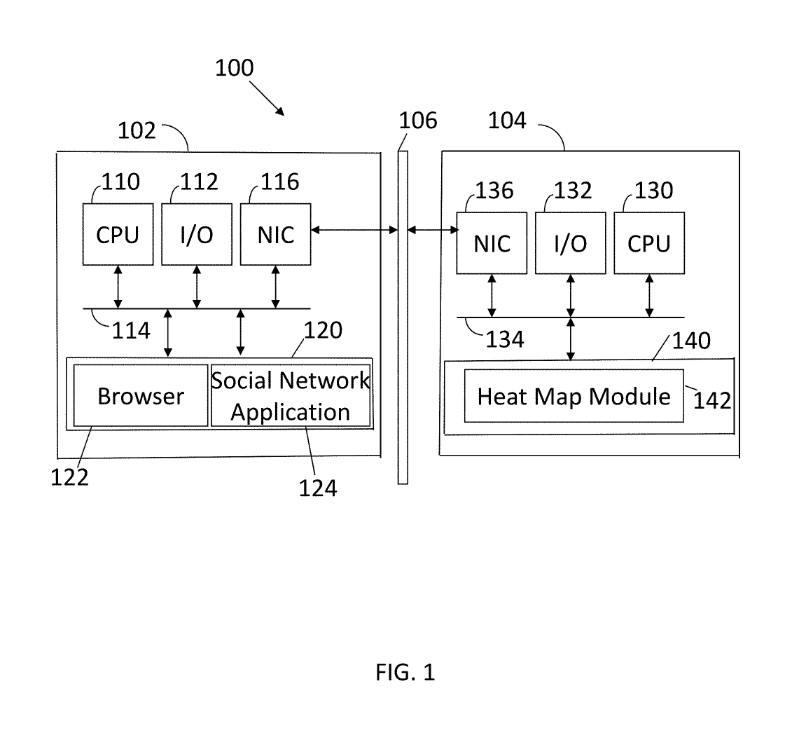

FIG. 1 illustrates an exemplary system 100 configured to generate heat map overlays representative of user preferences relating to rendered multimedia and textual content. The system 100 includes one or more client devices 102 in communication with a social network platform server 104 via a network 106, which may be any combination of wired and wireless network components.

Each client device 102 may include standard components, such as a central processing unit 110 connected to input/output devices 112 via a bus 114. The client device 102 may be a personal computer, tablet, smart phone, wearable device and the like. In the case of a client device 102 in the form of a portable communication device, the input/output devices 112 may include a touch-sensitive, pressure-sensitive or gesture-sensitive display screen capable of receiving user input via touches or gestures. In other implementations of client devices 102 the input/output devices 112 may include a keyboard, mouse, touch display and the like. A wired or wireless network interface circuit 116 is also connected to the bus 114 to provide connectivity to network 106. A memory 120 is also connected to the bus 114. The memory 120 stores a communication module, such as a browser 122 and a social network application 124. The social network may be, for example, Justhive®, which provides services facilitating the sharing of digital media and associated commentary among a network of users.

The social network platform server 104 also includes standard components, such as a central processing unit 130, input/output devices 132, bus 134 and network interface circuit 136 to provide connectivity to network 106. A memory 140 is also connected to the bus 134. The memory stores executable instructions, such as a heat map module 142 configured to generate heat map overlays, as discussed below. The heat map module 142 may include executable instructions to store and access user input received from client devices 102 in connection with describing heat map overlays, as demonstrated below.

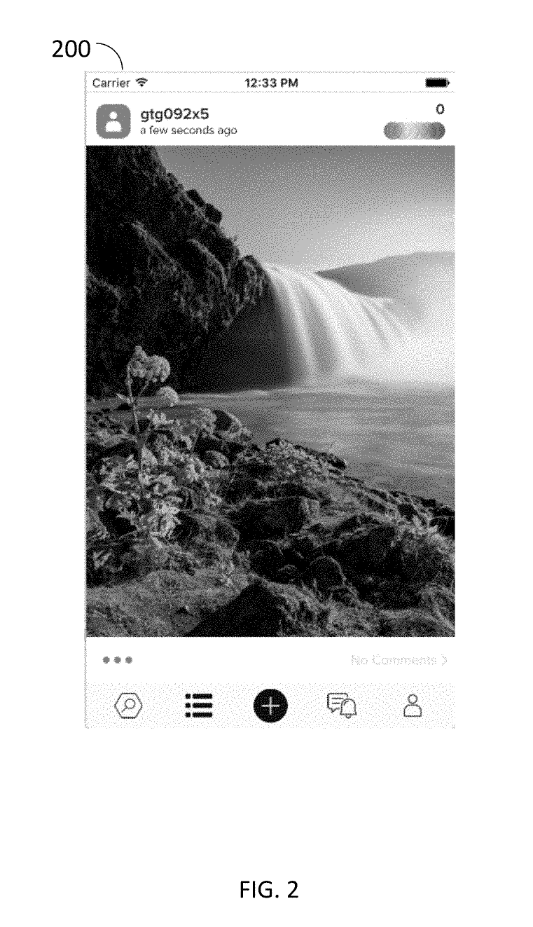

FIG. 2 illustrates a social network post 200 of an image designated as a “heat map” image that is utilized in accordance with an embodiment. Such an image accepts touch input anywhere on the image itself. In one embodiment a user of the social network application 124 may press on a position to highlight points of interest.

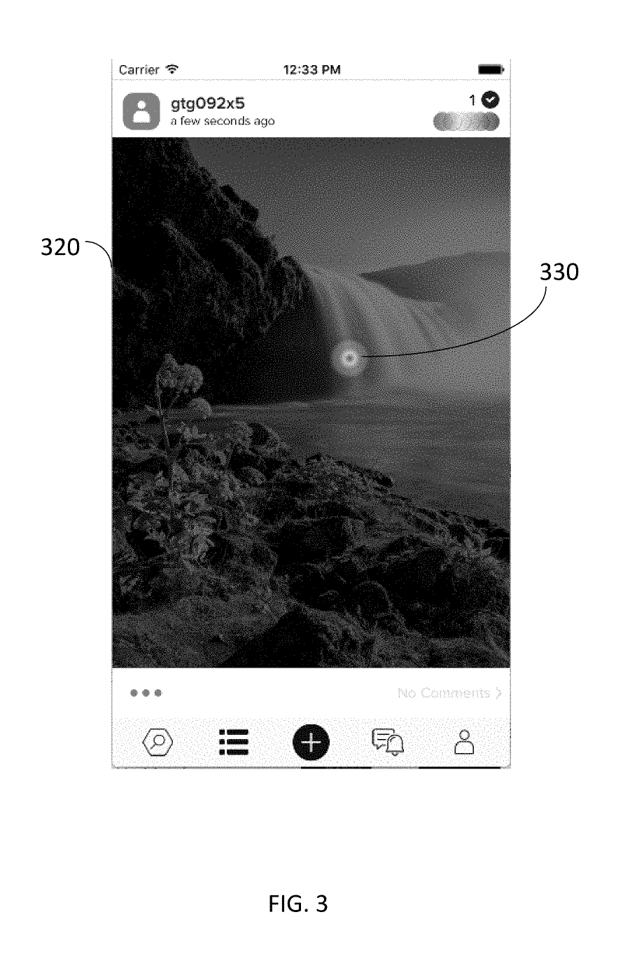

FIG. 3 illustrates a heat map overlay 310 superimposed over an image 320, in accordance with an embodiment. After accepting a user press or other user input, the coordinate position of the press and associated meta data is provided to and stored within memory 140. The meta data associated with the picture and may be represented with an overlay graphic that appears as a “heat map”. In one embodiment the heat map is representative of the relative popularity of a user press on the image or other user input applied to the image. If there are a small number of inputs, points that have the most interest will overlap and appear closer to a warmer color (e.g., red). Areas around these points will fade to a cooler color (e.g., blue).

### Heat Map Generation Through Aggregation of Crowd Input and Clustering

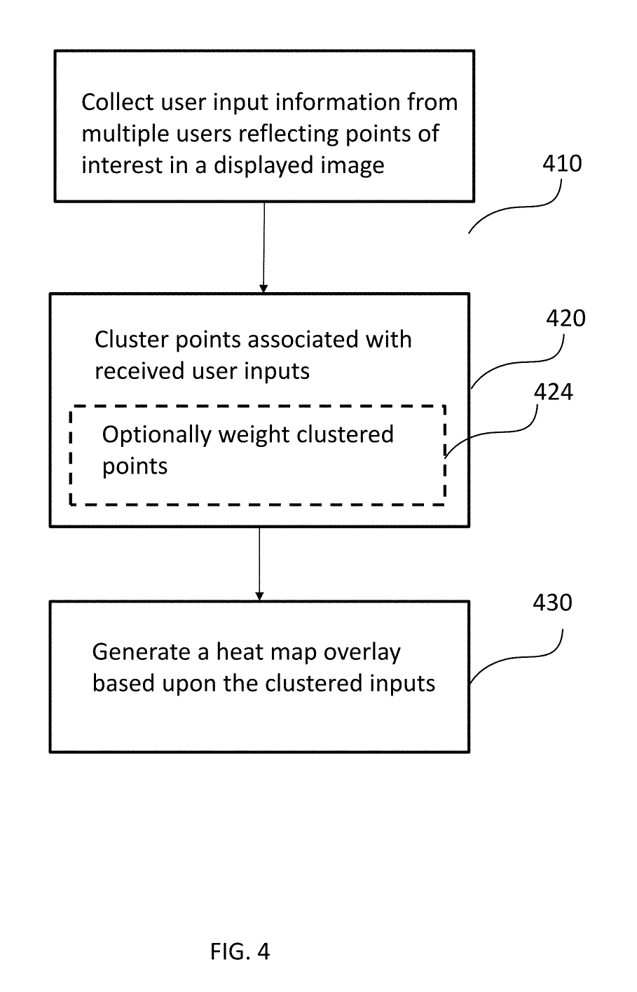

FIG. 4 is an exemplary simplified flow diagram representative of a process for providing heat map overlays, in accordance with some embodiments. As shown, the process may be initiated by collecting user input information from multiple users reflecting points of interest in a displayed image (stage 410). In one implementation multiple users may provide user input (e.g., pressing or touching) to portions of the same image presented by the user interfaces of their respective client devices 102. The coordinate locations corresponding to the locations on the displayed image corresponding to where this user input is received may then be provided by the client devices 102 to the platform server 104 and collected by the heat map module 142.

Once the heat map module 142 has collected the user input information from the client devices it may cluster points in the image corresponding to the received user inputs based on a density algorithm (stage 420). The density of user input with respect to an image will be reflected in a “heat map” overlay, with more clustered points being represented by larger regions and with warmer colors than less clustered points. In one implementation a DBSCAN clustering algorithm is employed to cluster points based upon the position of user input relative to the image. However, any density algorithm can be used if larger clusters are represented with more weight and heat on the overlay.

Once clustering based on the received user input has been performed, in one embodiment the clustered points are evaluated for weight. The clustered points may be weighted based upon meta information such as, for example, the time at which inputs corresponding to points in a cluster were received, the distances between the geographical locations associated with the inputs and a geographical location corresponding to the image, and the like (stage 424). In a particular implementation a scalar multiplier may be used to effect this weighting. For example, user touches made in the present day might be weighted 10× more than those made more than 30 days ago, and/or user touches made greater than 10 miles from a location associated with a photo might be weighted 10× less than those made within 10 miles.

As shown in FIG. 4, a heat map overlay may be generated based upon the clustered points in the image resulting from the above-described clustering process (stage 430). In one embodiment, an essentially a 1:1 mapping may exist between the output of the density algorithm for a particular (x,y) coordinate location of an image and the colors present in the heat map overlay for the image. That is, transparent areas of the heat map overlay lacking any colors will generally correspond to portions of the image for which the number of user inputs provided are currently below a threshold.

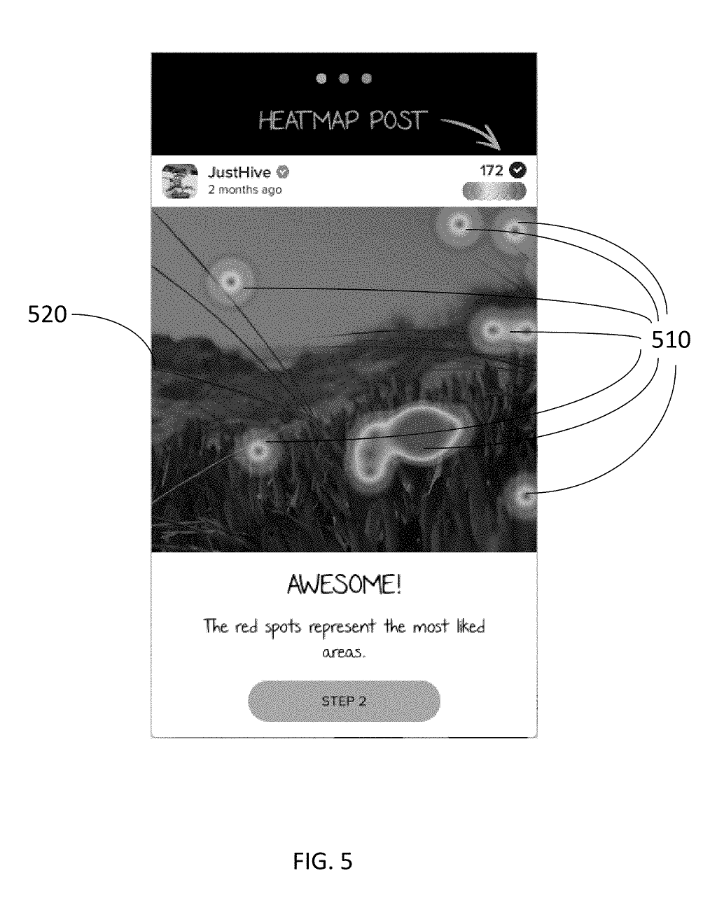

FIG. 5 illustrates a heat map overlay 510 generated in accordance with the process illustrated by FIG. 4. Although the heat map overlay 510 of FIG. 5 is generated with respect to an image of interest 520 being viewed by multiple users, the same or similar principles apply to the viewing of video content or other digital media.

### Creating a Heat Map Post

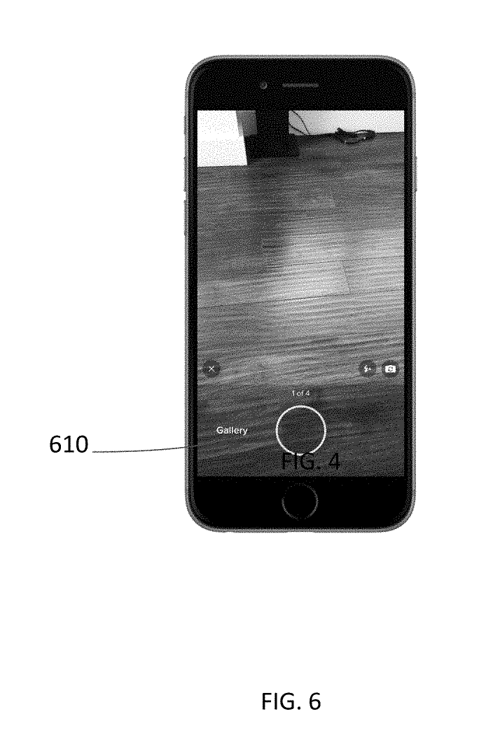

FIGS. 6-11 illustrate an exemplary series of user interfaces utilized in creating a heat map post.

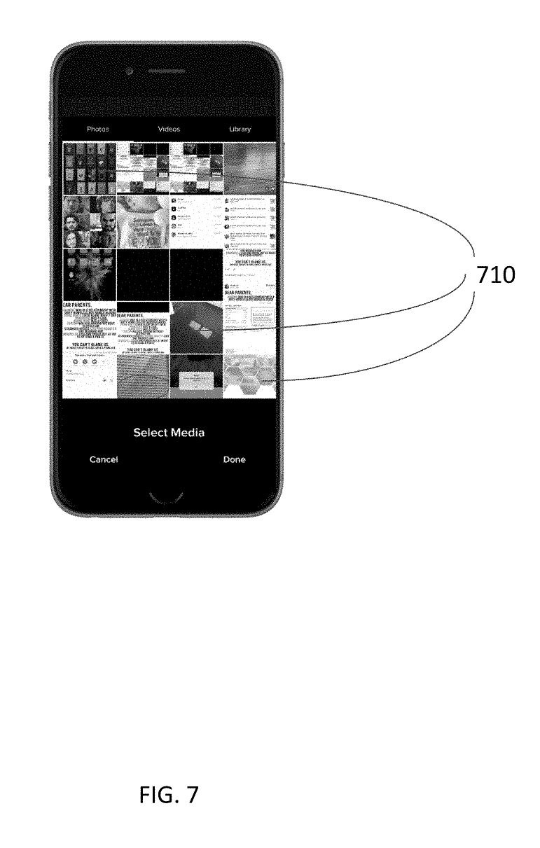

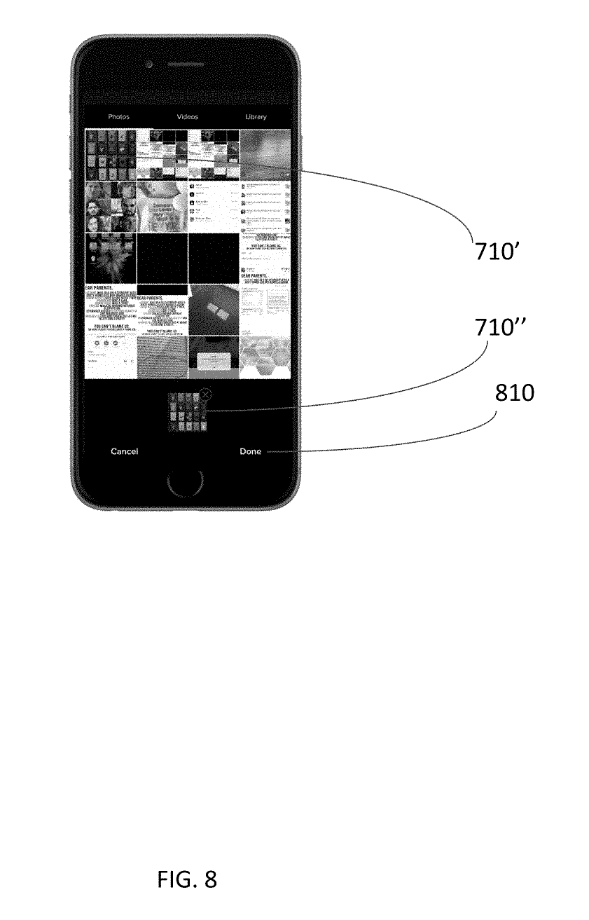

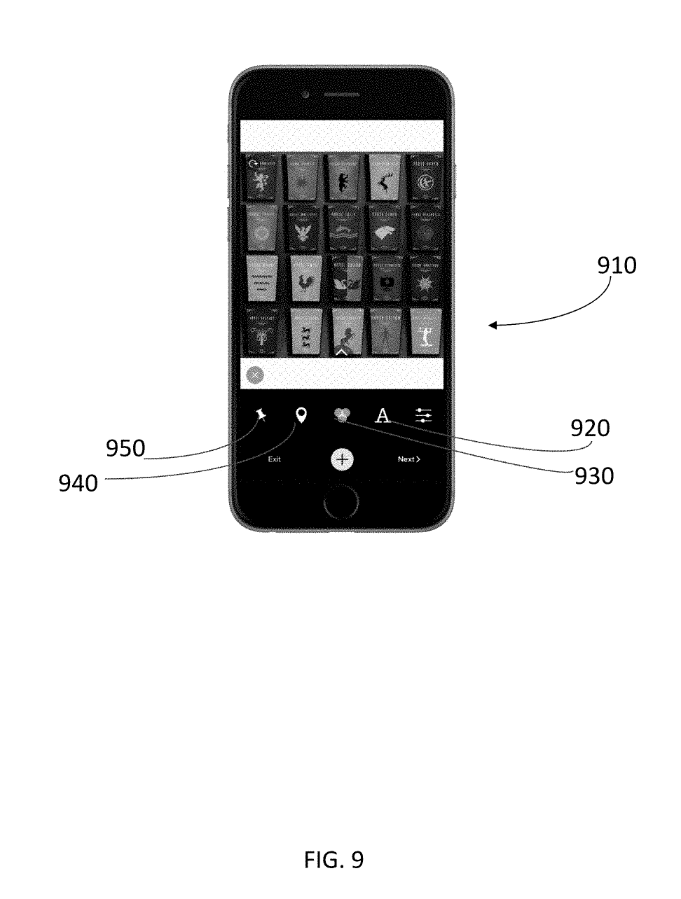

As shown in FIG. 6, a user is taken to the camera of the client device 102 when creating a post. In order to select an existing photo from their library, a user may select Gallery 610 or the equivalent. Referring to FIG. 7, once Gallery 602 is selected, the user's library photos 710 appear for selection. As is indicated by FIG. 8, a user may select which photo 710′ they would like to post and then taps on the Done selection 810. In one embodiment a thumbnail or reduced resolution version 710″of the selected photo 710′ is displayed below the remaining library photos. After tapping on the Done selection 810, the user is taken to an editing screen. As shown in FIG. 9, in one embodiment an editing screen 910 enables users to crop, edit, or add text 920 to the image as well as add filters 930, locations 940, or pins 950, and when finished, tap Next.

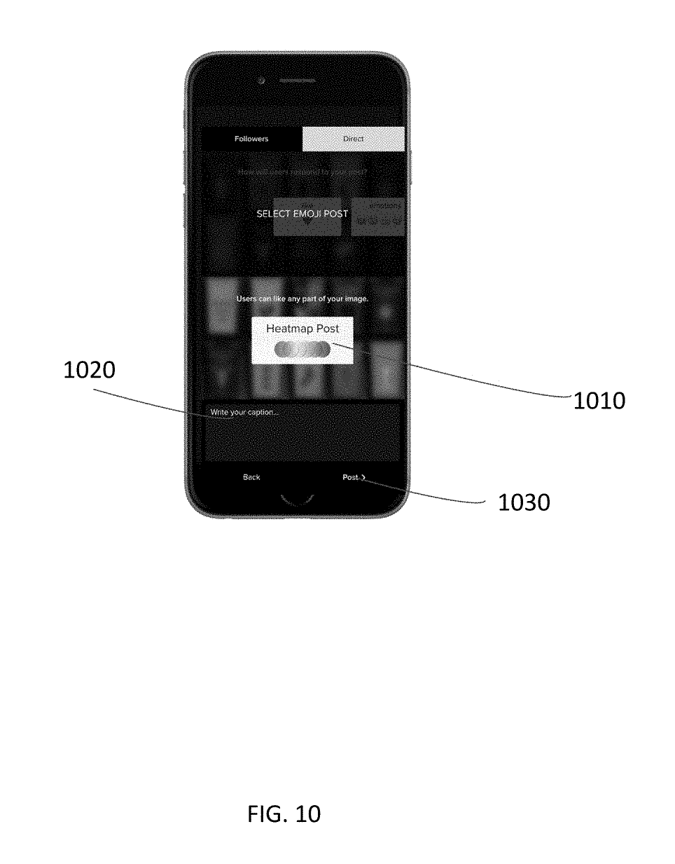

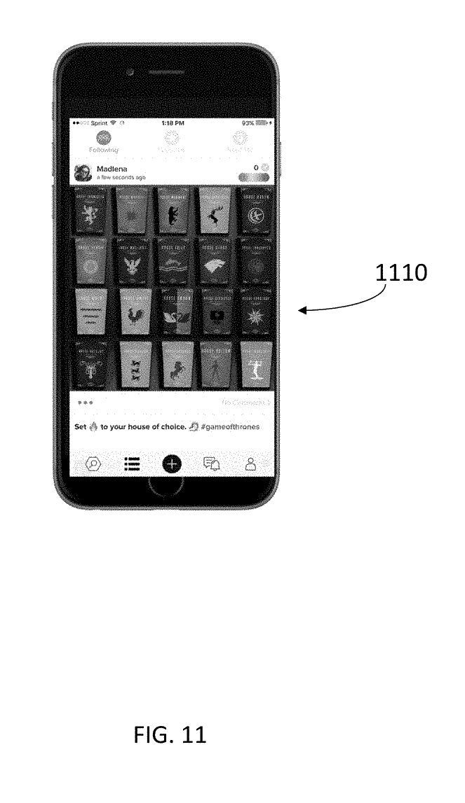

Referring to FIGS. 10 and 11, in order to select the heat map feature the user taps a Heatmap Post icon 1010. A user can also add a caption for their post in a text entry box 1020. When creation of the Heatmap Post has been completed, the user may tap the Post selection 1030. A user is then taken to the feed 1110 where their Heatmap Post is uploaded and ready for viewing and to be voted on by other users.

### Voting on Heat Map Post

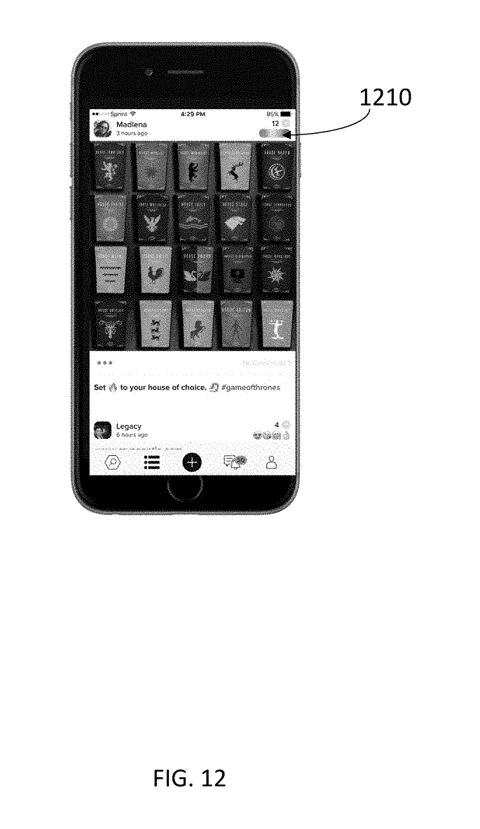

FIGS. 12-14 illustrate an exemplary series of user interfaces utilized in voting on a heat map post.

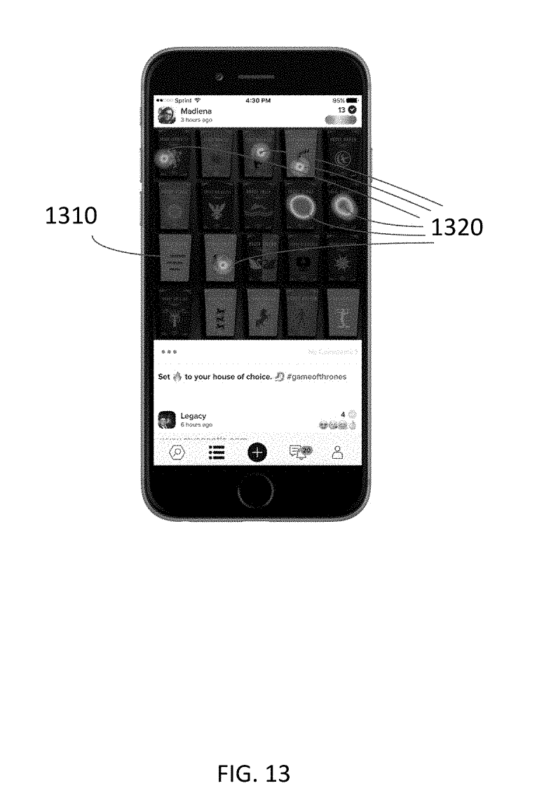

Referring to FIG. 12, posts may be distinguished by the icons on the top right of the image. In one embodiment a viewer is able to recognize that a given post is a heatmap post by the presence of a heat map highlight 1210. In one embodiment a user is not permitted to request or view a heat map overlay superimposed over an image included within a post until the user places a vote with respect to the post. As may be appreciated from reference to FIG. 13, in one embodiment a user places a vote by double-tapping at a position of interest to the user on the image 1310. The user's vote is then registered and the user is permitted to view the heat map 1320 superimposed upon the image 1310. Again, in one embodiment the size and color of portions of the heat map reflect a density of user inputs received from multiple users relative to points within the image 1310.

In the case of video content, a user may place a vote by providing input while the video is playing or by first pausing the video at a particular frame in order to provide input. In one embodiment the heat map module 142 records user input for a particular position in a particular frame of the video and uses this input in generating the heat map overlay pertinent to the particular frame of the video.

In one embodiment, a heat map overlay is displayed over frames of a video and generally changes on a frame-by-frame basis while the video is played based upon the votes received from users with respect to particular frames. In particular, votes in the form of user inputs can be timecoded and can be displayed over video for short periods of time around the timecode at which the input was recorded. With respect to the heat map to be generated in association with a particular timecode, user inputs received during portions of the video closer to the timecode are weighted more heavily than user inputs received for portions of the video farther away in time from the timecode. For example, an inverse scalar multiplier that is a function of the difference between the timecode of interest and the time of user input may be applied to the user inputs. Input could be gathered in real time and rendered in the form of heat map overlay to play on top of a video. The overlay would preferably change on a frame by frame basis in accordance with the recorded and weighted user inputs while the video plays.

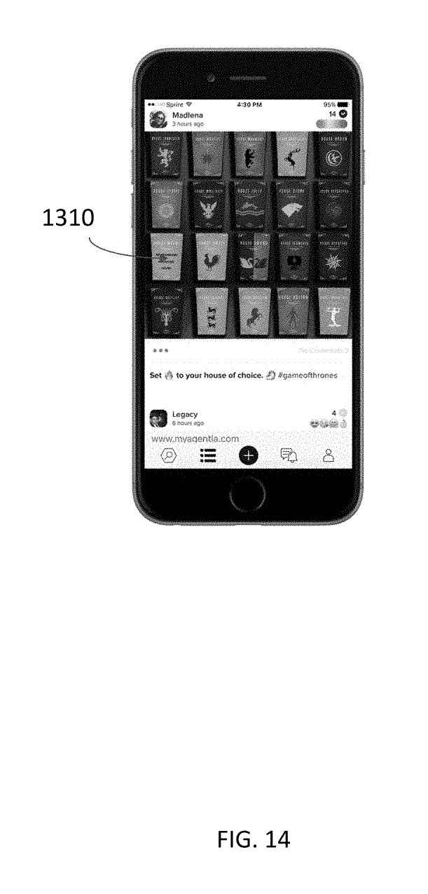

Referring to FIG. 14, once a user interface including the heat map overlay superimposed over the image has been rendered, a user may remove the heat map overlay from the user interface by tapping on the image 1310. In order again superimpose a heat map overlay upon the image 1310, the viewer taps on the image 1310.

### Heat Map Feedback Reflecting User Interest in Textual Content

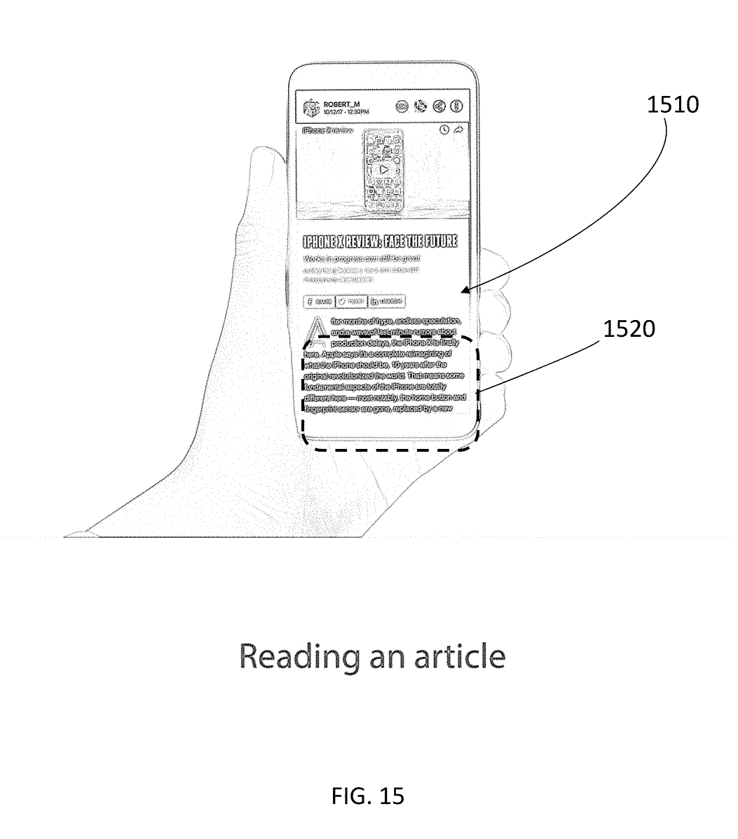

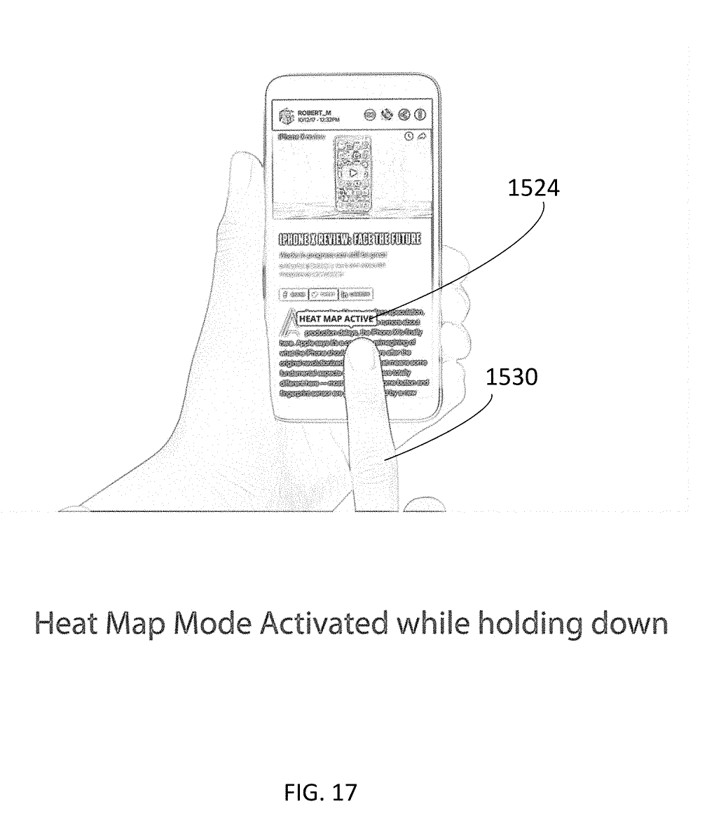

FIGS. 15-21 illustrate an exemplary series of user interactions with textual content presented by a user interface as well as heat map feedback reflecting an aggregate user interest in corresponding portions of the textual content.

Referring to FIG. 15, a user may open a post 1510 or other content of interest posted to the social network application 124. The post 1510 will have text 1520 presented by the application 124 with which the user may interact or simply identify as being of interest. For example, in the event a user likes the content of the post 1510 or is otherwise interested in identifying a portion of the text 1520 of interest, the user may highlight it.

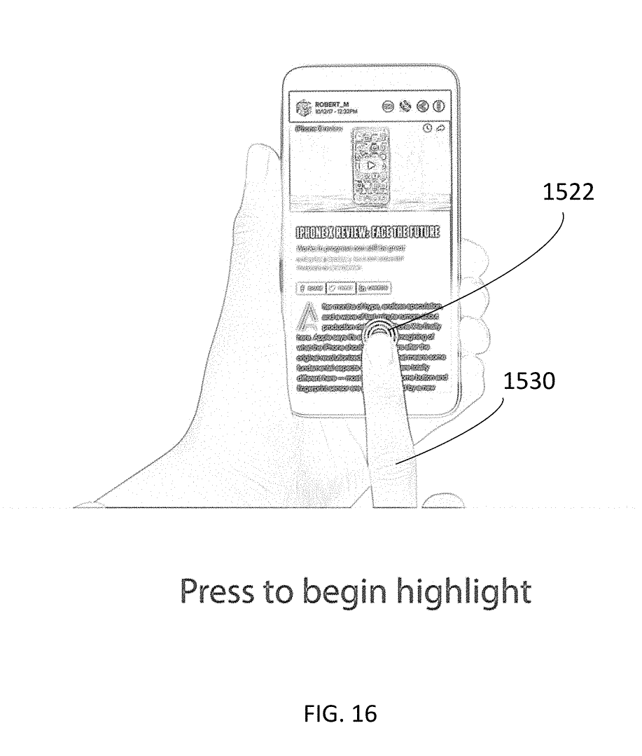

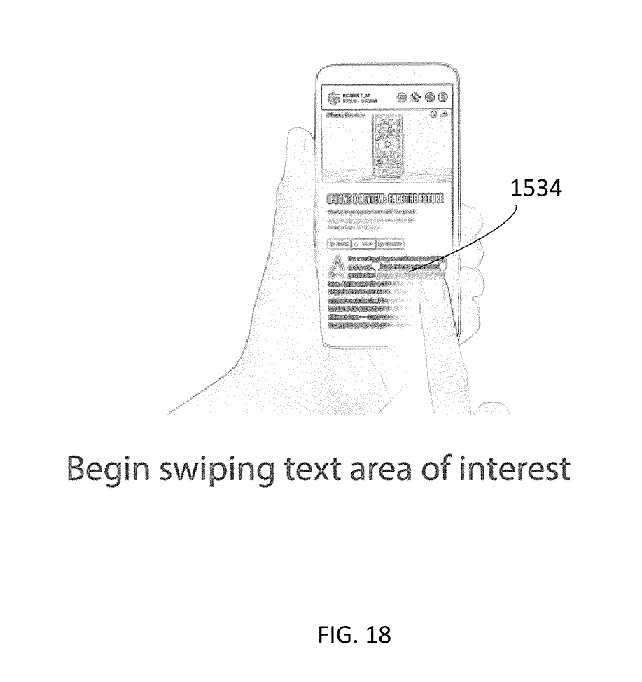

As indicated by FIGS. 16-18, in one embodiment the user may press and hold on an initial word 1522 of the text 1520 of interest until the user feels, for example, a vibration and/or are provided with a visual queue. Such a visual queue could comprise, for example, a heat map icon 1524 configured to pop up above the user's finger 1530 upon pressing and holding on the initial word of interest in the text 1520. The user may select additional text 1520 of interest by, for example, swiping their finger over the additional words the user desires to select. As shown in FIG. 18, in one embodiment a highlight overlay 1534 appears over the portions of the text 1520 selected by the user in this manner.

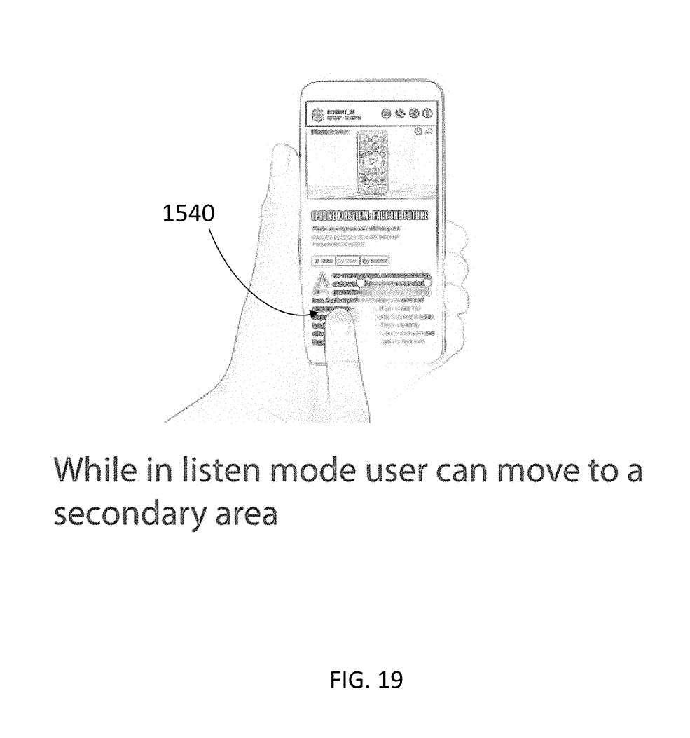

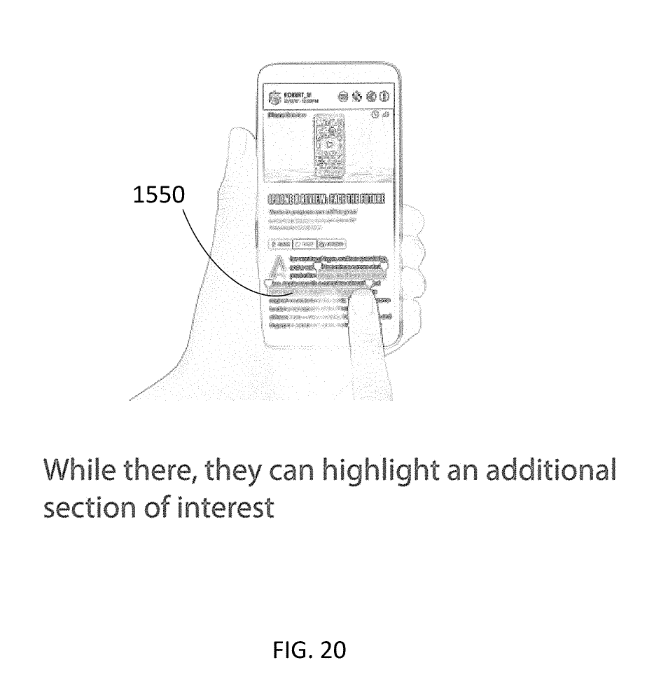

Referring to FIGS. 19 and 20, a heatmap service of the application 124 may transition to a LISTEN mode once the text selection process described above has been initiated by the user. During LISTEN mode, this service of the application 124 will be monitoring the finger gestures of the user via the touch-sensitive or gesture-sensitive user interface in order to ascertain the portions of the text 1520 desired to be highlighted. As indicated by FIGS. 19 and 20, during operation in the LISTEN mode the user may lift their finger from the screen and move to a new section or line 1540 of the text 1520 and select additional text, for which a highlight overlay 1550 is then generated. In one embodiment the heatmap service will transition out of the LISTEN mode once the user has lifted their finger for more than 2 seconds. At this point the text highlighted by the user is registered by the application 124 as being “liked” or otherwise of interest.

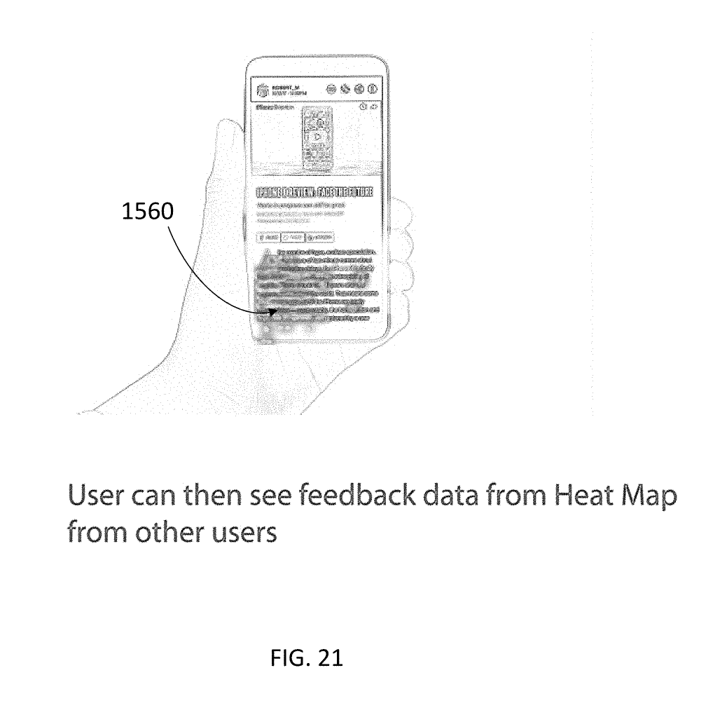

Referring now to FIG. 21, once the text highlighted by the user has been registered, the highlighting overlays present during LISTEN mode may be replaced by a heatmap overlay 1560 generated by the application 124. In one embodiment the heatmap overlay 1560 provides feedback relating to the extent to which portions of text 1520 highlighted by the user were also liked by other users. For example, the heatmap overlay 1560 may include a spectrum of colors including, for example, red, orange, yellow, green and blue. In one implementation the red areas of the heatmap overlay 1560 indicate portions of the text 1520 most popular with other users and blue areas of the heatmap overlay 1560 correspond to portions of the text 1520 least popular with other users. The orange, yellow and green areas of the heatmap 1560 correspond to portions of the text 1520 of progressively less interest to other users relative to the red portions of the text 1520. Areas of the heatmap overlay 1560 lacking any color correspond to areas of the text 1520 that haven't yet been highlighted by any users.

While various embodiments have been described above, it should be understood that they have been presented by way of example only, and not limitation. They are not intended to be exhaustive or to limit the claims to the precise forms disclosed. Indeed, many modifications and variations are possible in view of the above teachings. The embodiments were chosen and described in order to best explain the principles of the described systems and methods and their practical applications, they thereby enable others skilled in the art to best utilize the described systems and methods and various embodiments with various modifications as are suited to the particular use contemplated.

Where methods described above indicate certain events occurring in certain order, the ordering of certain events may be modified. Additionally, certain of the events may be performed concurrently in a parallel process when possible, as well as performed sequentially as described above. Although various modules in the different devices are shown to be located in the processors of the device, they can also be located/stored in the memory of the device (e.g., software modules) and can be accessed and executed by the processors. Accordingly, the specification is intended to embrace all such modifications and variations of the disclosed embodiments that fall within the spirit and scope of the appended claims.

The foregoing description, for purposes of explanation, used specific nomenclature to provide a thorough understanding of the claimed systems and methods. However, it will be apparent to one skilled in the art that specific details are not required in order to practice the systems and methods described herein. Thus, the foregoing descriptions of specific embodiments of the described systems and methods are presented for purposes of illustration and description. They are not intended to be exhaustive or to limit the claims to the precise forms disclosed; obviously, many modifications and variations are possible in view of the above teachings. The embodiments were chosen and described in order to best explain the principles of the described systems and methods and their practical applications, they thereby enable others skilled in the art to best utilize the described systems and methods and various embodiments with various modifications as are suited to the particular use contemplated. It is intended that the following claims and their equivalents define the scope of the systems and methods described herein.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded into one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising:
receiving, by a processor, user input data corresponding to user inputs received by a plurality of user devices with respect to image content rendered by the plurality of user devices wherein the user input data identifies points in the image content at which the user inputs were respectively received;
clustering, by the processor, the user inputs so as to provide a density of user input relative to the image content; and
generating, by the processor, a heat map overlay for display by ones of the plurality of user devices wherein the heat map overlay is representative of the density of the user inputs relative to the image content.

2. The method of claim 1 further including receiving, from the ones of the plurality of user devices, requests for display of the heat map overlay.

3. The method of claim 1 wherein the clustering is performed in accordance with a density algorithm configured to cluster the points in the image content, thereby generating a plurality of clusters.

4. The method of claim 1 wherein the generating includes representing ones of the clusters corresponding to a relatively higher density of user input as larger regions within the heat map overlay.

5. The method of claim 4 wherein the generating further includes using relatively warmer colors within the larger regions.

6. The method of claim 3 further including weighting the points in at least one of the plurality of clusters.

7. The method of claim 6 wherein the weighting is based upon times at which the user inputs corresponding to points in the at least one of the plurality of clusters were received.

8. The method of claim 6 wherein the weighting is based upon distances between geographical locations at which the user inputs corresponding to the points in the at least one of the plurality of clusters were received and a geographical location associated with the image content.

9. The method of claim 1 wherein the generating includes mapping a value of the density for each of the points in the image content to a color used within the heat map overlay.

10. The method of claim 1 wherein transparent areas of the heat map overlay correspond to portions of the image content for which a number of the user inputs received is below a threshold.

11. A system, comprising:
a processor; and
a memory containing instructions that, when executed by the processor, cause the processor to:
receive user input data corresponding to user inputs received by a plurality of user devices with respect to image content rendered by the plurality of user devices wherein the user input data identifies points in the image content at which the user inputs were respectively received;
cluster the user inputs so as to provide a density of user input relative to the image content; and
generate a heat map overlay for display by ones of the plurality of user devices wherein the heat map overlay is representative of the density of the user inputs relative to the image content.

12. The system of claim 11 wherein the instructions further include instructions that, when executed by the processor, cause the processor to receive, from the ones of the plurality of user devices, requests for display of the heat map overlay.

13. The system of claim 11 wherein the instructions further include instructions that, when executed by the processor, cause the processor to cluster the user inputs in accordance with a density algorithm so as to cluster the points in the image content, thereby generating a plurality of clusters.

14. The system of claim 11 wherein the instructions further include instructions that, when executed by the processor, cause the processor to represent ones of the clusters corresponding to a relatively higher density of user input as larger regions within the heat map overlay.

15. The system of claim 14 wherein the instructions further include instructions that, when executed by the processor, cause the processor to use relatively warmer colors within the larger regions when generating the heat map overlay.

16. The system of claim 13 wherein the instructions further include instructions that, when executed by the processor, cause the processor to weight the points in at least one of the plurality of clusters.

17. The system of claim 16 wherein the instructions further include instructions that, when executed by the processor, cause the processor to weight the points in at least one of the plurality of clusters based upon times at which the user inputs corresponding to points in the at least one of the plurality of clusters were received.

18. A method, comprising:
receiving, through a user interface of a user device, user input with respect to image content rendered by the user interface;
generating, by a processor, user input data identifying at least one point in the image content at which the user input was received;
sending the user input data to a server;
receiving, at the user device, a heat map overlay wherein the heat map overlay is representative of a density of user inputs applied to a plurality of user devices relative to the image content wherein the user device is included within the plurality of user devices; and
displaying, by the user interface, the heat map overlay superimposed over the image content.

19. The method of claim 18 wherein the density of user inputs is determined in accordance with a density algorithm configured to cluster points in the image content corresponding to the user inputs, thereby generating a plurality of clusters.

20. The method of claim 19 wherein one or more of the points associated with each of the plurality of clusters is weighted as part of generating the heat map overlay.
